(19) United States
(12) Patent Application Publication
(10) Pub. No.: US 2026/0346881 A1
(43) Pub. Date: Nov. 5, 2026

(54) HYBRID LOCOMOTIVE WITH ACTIVE RECTIFIER

(71) Applicant: Progress Rail Locomotive Inc., LaGrange, IL (US)

(72) Inventors: Rafael Grott de Carvalho, Curitiba (BR); Sidarta F. Beltramin, Curitiba (BR)

(73) Assignee: Progress Rail Locomotive Inc., LaGrange, IL (US)

(21) Appl. No.: 19/194,283

(22) Filed: Apr. 30, 2025

(51) Int. Cl. B61C 7/04; H02P 9/48; H02P 101/40

(52) U.S. Cl. CPC B61C 7/04; H02P 9/48; H02P 2101/40

(57) ABSTRACT

An active rectifier for use with a hybrid locomotive is described that provides power quality improvement through active rectification compared to traditional passive rectification systems. The active rectifier enables voltage boosting functionality that allows for effective battery integration by matching required voltage levels. The active rectifier system may operate in reverse as an inverter to provide engine cranking capability.

### FIELD OF THE DISCLOSURE

This document pertains generally, but not by way of limitation, to locomotives and, more particularly, to hybrid locomotives.

### BACKGROUND

A train typically includes at least one locomotive for propelling the vehicle by wheels along tracks. In a diesel-electric locomotive, a diesel engine often serves as the primary motive source, or prime mover, within the locomotive. The diesel engine drives an alternator, which produces three-phase alternating current (AC). This AC current is then passed through a rectifier to convert it into direct current (DC), as DC power is used for operating the locomotive's systems. The DC bus acts as a central distribution point, receiving the rectified DC power and delivering it to various subsystems. The DC bus supplies power to traction motors, which rotate the wheels. The DC bus also supports auxiliary systems, such as cooling fans, air compressors, and lighting, often through additional converters.

U.S. Pat. No. 7,906,862B2 describes a control strategy for operating a plurality of prime power sources during propulsion, idling and braking and is applicable to large systems such as trucks, ships, cranes and locomotives utilizing diesel engines, gas turbine engines, other types of internal combustion engines, fuel cells or combinations of these that require substantial power and low emissions utilizing multiple power plant combinations. It is directed at a general control strategy for multi-engine systems where the power systems need not be of the same type or power rating and may even use different fuels. It is based on a common DC bus electrical architecture so that prime power sources need not be synchronized.

### SUMMARY OF THE DISCLOSURE

This disclosure describes an active rectifier for use with a hybrid locomotive. The active rectifier provides power quality improvement through active rectification compared to traditional passive rectification systems. The active rectifier enables voltage boosting functionality that allows for effective battery integration by matching required voltage levels. The active rectifier system may operate in reverse as an inverter to provide engine cranking capability.

In some aspects, this disclosure is directed to a hybrid locomotive including a combustion engine and a battery pack, the hybrid locomotive comprising: an electric motor-generator coupled with the combustion engine, wherein a driveshaft of the combustion engine is coupled with the electric motor-generator; an active rectifier coupled between the electric motor-generator and the battery pack, wherein the active rectifier includes a plurality of transistors configured to selectively control a flow of current across a DC bus coupled between the active rectifier and the battery pack, wherein the active rectifier is configured to increase a DC bus voltage to match a battery pack voltage; and a control circuit in communication with the active rectifier and configured to control a switching operation of the plurality of transistors.

In some aspects, this disclosure is directed to a method of operating a hybrid locomotive having a combustion engine and a battery pack, the method comprising: controlling, by a control circuit, a switching operation of a plurality of transistors of an active rectifier coupled between an electric motor-generator and the battery pack to selectively control a flow of current across a DC bus coupled between the active rectifier and the battery pack; increasing, by the active rectifier, a DC bus voltage to match a battery pack voltage; and operating the electric motor-generator in at least one of: a motor mode to start the combustion engine using current from the battery pack; or a generator mode to charge the battery pack.

In some aspects, this disclosure is directed to a control system for a hybrid locomotive having a combustion engine and a battery pack, comprising: an active rectifier coupled between an electric motor-generator and the battery pack, the active rectifier including a plurality of transistors configured to selectively control current flow across a DC bus coupled between the active rectifier and the battery pack; and a control circuit configured to: control switching of the plurality of transistors to operate the active rectifier as a rectifier during a generator mode and as an inverter during a motor mode; increase a DC bus voltage to match a battery pack voltage during the generator mode; and control current flow from the battery pack to start the combustion engine during the motor mode.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1 is a side view of an example of a hybrid locomotive that may implement various techniques of this disclosure.

FIG. 2 is a block diagram of general components within the first power subsystem, the second power subsystem, and the distributed control system of FIG. 1.

FIG. 3 is a block diagram of an example of a hybrid locomotive power system that may implement various techniques of this disclosure.

FIG. 4 is a schematic view of an example of the active rectifier of FIG. 3.

FIG. 5 is a graph depicting voltage relationships in the hybrid locomotive power system.

FIG. 6 is a block diagram of an example of a hybrid locomotive power system that may be used to start the combustion engine.

FIG. 7 depicts an example of a field excitation circuit implemented by the control circuit of FIG. 6 to assist with engine start.

FIG. 8 depicts an example of a current control loop implemented by the control circuit 316 of FIG. 6 to assist with engine start.

FIG. 9 depicts an example of a controller and a control loop implemented by the control circuit of FIG. 6 to boost the DC link voltage V_{DC} to match the battery voltage V_{BAT}.

FIG. 10 depicts an example of a control loop used to generate the field coil duty cycle signal I_{FIELD}.

FIG. 11 is a flow diagram of an example of a method of operating a hybrid locomotive having a combustion engine and a battery pack.

### DETAILED DESCRIPTION

The present inventors have identified problems with passive rectification systems in hybrid locomotive applications. First, passive rectification produces poor power quality from the generator's perspective, which may lead to inefficient power conversion and potential system performance issues. Second, passive rectification systems have a significant limitation at low diesel engine speeds—they cannot provide high DC link voltage levels. This limitation forces the engine to operate at higher speeds to achieve the necessary voltage levels, resulting in increased fuel consumption. The present inventors have recognized a need to use active rectification in hybrid locomotive applications.

This disclosure describes an active rectifier for use with a hybrid locomotive. The active rectifier provides power quality improvement through active rectification compared to traditional passive rectification systems. The active rectifier enables voltage boosting functionality that allows for effective battery integration by matching required voltage levels. The active rectifier system may operate in reverse as an inverter to provide engine cranking capability.

FIG. 1 is a side view of an example of a locomotive 100 that may implement various techniques of this disclosure. The locomotive 100 functions as a rail vehicle and travels along tracks or rails 102 from a source to a destination (from left to right in FIG. 1) using wheels 104. Although depicted as a single car, the locomotive 100 may be part of a group of locomotives or affiliated rail vehicles functioning together as a consist. Accordingly, the structure and function of the locomotive 100 may, in some examples, be distributed across a variety of railroad cars that are coupled together directly or indirectly.

A cab 106 is positioned at a front of the locomotive 100 facing the direction of travel along the rails 102. The operator, or conductor, of the locomotive 100 is stationed within the cab 106 during operation. The cab 106 may include a workstation with various human-machine interfaces, such as controls, instruments, and indicators, useful for operating the locomotive 100.

For propulsion, the locomotive 100 shown in FIG. 1 includes a power system that includes a first power subsystem 108, a second power subsystem 110, and a distributed control system 112. In some examples, the locomotive 100 functions under propulsion to drive the wheels 104 from input by the first power subsystem 108 and the second power subsystem 110 operating either together or alternately. The second power subsystem 110 may operate as a supplemental or backup source of power to the first power subsystem 108, such as when the locomotive 100 needs additional tractive effort, when fuel levels or environmental regulations dictate certain operating conditions, or other situations known to those of ordinary skill in the field. The distributed control system 112 helps coordinate and balance the contributions of power for the locomotive 100 between the first power subsystem 108 and the second power subsystem 110 under computer control for the particular rail vehicle and its mission.

In some examples, the first power subsystem 108 of FIG. 1 is generally embodied in an internal combustion engine that burns fuel to propel the locomotive 100. In some implementations, the engine is a diesel-electric engine, such as a uniflow two-stroke diesel engine system. Typically, the engine includes a relatively large diesel engine, for example, having 4500 horsepower (HP). For example, the engine may be one of the EMD 710 and 1010J series engines or Caterpillar C175 and 3500 series engines. Alternatively, the engine may be a four-stroke internal combustion engine. In general, the engine may be any engine running on solid, liquid, or gaseous fuel.

In some examples, the second power subsystem 110 of FIG. 1 is generally embodied in a battery pack that may also provide a source of DC voltage to the DC bus. The battery may include one or more batteries, capacitors, super-capacitors, ultra-capacitors, flywheels, accumulators, or other mechanisms for storing electrical energy known to those of ordinary skill in the field. The battery pack may be a Li-Ion propulsion battery, or may provide energy from alternative energy source such as hydrogen.

In some examples, the battery pack includes a plurality of battery strings. Each battery string includes a plurality of battery modules, where each battery module includes a plurality of battery cells. When the locomotive 100 is in operation, the battery pack provides electrical energy directly to various components, including a traction motor, which drives the wheels 104. The traction motor receives a controlled flow of power to generate sufficient torque to move the train forward or in reverse.

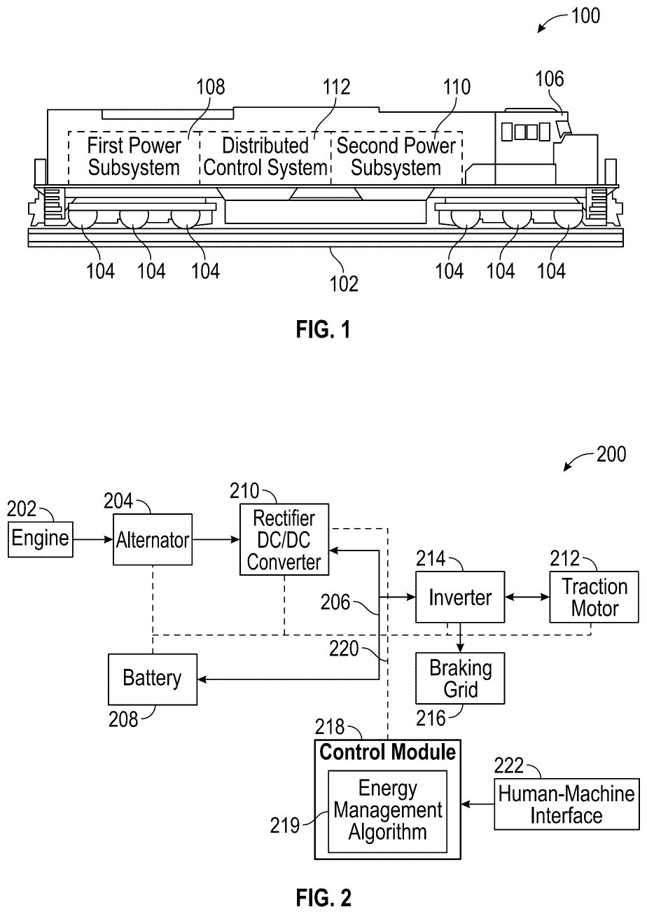

FIG. 2 is a block diagram 200 of general components within the first power subsystem 108, the second power subsystem 110, and the distributed control system 112 of FIG. 1.

The engine 202 generates a torque that is transmitted to an alternator/rectifier 204 along a drive shaft. As part of the first power subsystem 108, the alternator/rectifier 204 at first converts the mechanical or kinetic energy from the torque to electrical energy in the form of alternating current (AC) voltage. The alternator/rectifier 204 then also contains silicon diode rectifiers or similar electrical components sufficient to convert the AC voltage to a direct current (DC) voltage. Additional components may be included with an alternator/rectifier 204 to provide a stable and consistent DC voltage having desired characteristics in a manner known by those of ordinary skill in the field. The DC voltage resulting from alternator/rectifier 204 is then supplied to a DC bus 206 for distribution to other elements of the power system of locomotive 100.

A DC/DC converter 210 is configured between the battery 208 and the DC bus 206 as part of the second power subsystem 110 to accommodate a difference in voltage handled by battery 208 and DC bus 206. As with the engine 202 and the alternator/rectifier 204, the battery 208 may provide an alternative or supplemental source of electrical energy for the DC bus 206. Additionally, the battery 208 may be charged during operation of the locomotive 100 via the DC bus 206 according to processes known to those of ordinary skill in the art.

In addition to coupling the engine 202 within the first power subsystem 108 and the battery 208 within the second power subsystem 110, the DC bus 206 also couples those power subsystems with at least one electrical traction motor 212. The traction motor 212 provides final propulsion to the wheels 104 from electrical power received from the power system. Typically, one traction motor 212 is disposed in the locomotive 100 in proximity to the rails 102 so as to rotate an axle driving a pair of the wheels 104.

The representative traction motor 212 may be an alternating current (AC) traction motor or a direct current (DC) traction motor. When the traction motor 212 is an AC traction motor, the alternator/rectifier 204 provides DC voltage as the primary power source to the DC bus 206, and the inverter 214 converts the DC voltage on the DC bus 206 to AC voltage to provide electrical power in the appropriate form for the traction motor 212. In this example, the inverter 214 may include one or more inverters and other components known to those skilled in the field for providing the appropriate electrical conversion based on the needs of the traction motor 212. When the traction motor 212 is a DC traction motor, the inverter 214 may be a converter module having DC chopper circuits and affiliated electrical devices to convert a constant DC electrical voltage from the DC bus 206 into a variable DC electrical power source appropriate for the DC traction motor. Typically, the conversion of DC electrical power for use by DC traction motors includes using pulse width modulation (PWM) within the DC/DC converter 210.

In addition to operating as a motor, in which the traction motor 212 receives electrical power from the DC bus 206 to generate torque on an axle of the wheels 104 to propel the locomotive 100, the traction motor 212 may be operable as a generator, in which torque on the axle from the moving the locomotive 100 causes the traction motor 212 to generate electrical power. When acting as a generator, the traction motor 212 may provide dynamic braking to resist rotation of the wheels 104 for the moving locomotive 100. Dynamic braking may provide lower maintenance by reducing wear on friction-based mechanical brakes and smoother deceleration for the locomotive 100 than would be provided by mechanical or pneumatic braking using disk or drum brakes. In addition, as a generator, the traction motor 212 provides electrical power through the inverter 214 to the DC bus 206, which may be stored, otherwise used by the locomotive 100 for various purposes, or dissipated. Specifically, in one form, dynamic braking by the traction motor 212 may be rheostatic, where the electrical power generated by the traction motor 212 is captured by a grouping of resistors and affiliated components within a braking grid 216 and dissipated as heat. In another form, dynamic braking by the traction motor 212 may be regenerative, where the electrical power generated by the traction motor 212 is recaptured and stored within the battery 208 for further use by the locomotive 100.

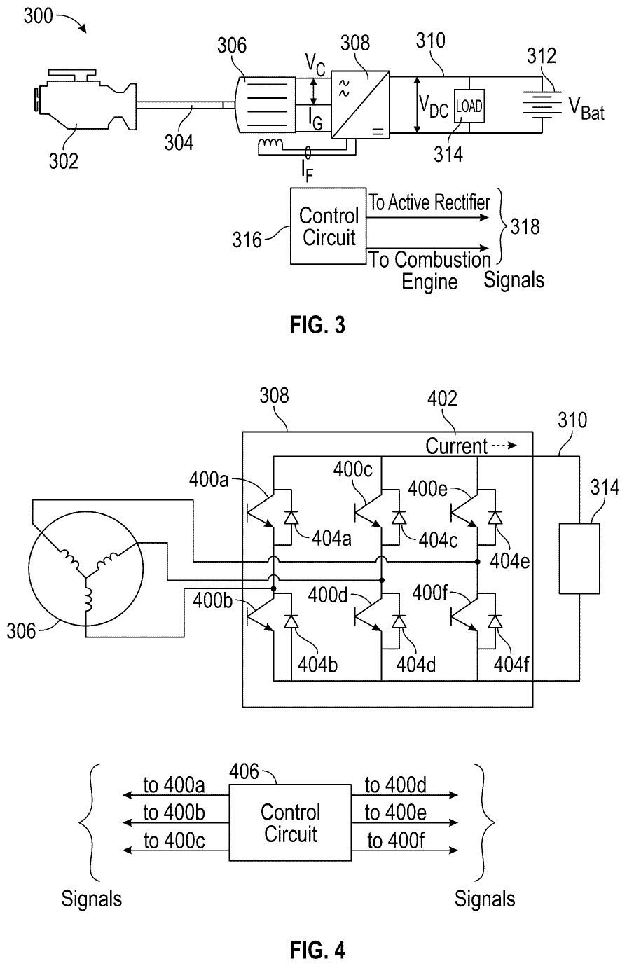

FIG. 3 is a block diagram of an example of a hybrid locomotive power system 300 that may implement various techniques of this disclosure. The power system 300 includes components of the first power subsystem 108 and the second power system subsystem 110 of FIG. 1.

Starting from the left, the power system 300 includes a combustion engine 302. A driveshaft 304 is coupled between the combustion engine 302 and an electric motor-generator 306. An active rectifier 308 is coupled with a DC bus 310, and the DC bus 310 is coupled with an electric electrical load 314 and a battery pack 312. As shown in FIG. 4, the active rectifier 308 includes a plurality of transistors configured to selectively control a flow of current across the DC bus 310 coupled between the active rectifier 308 and the battery pack 312.

The current of the electric motor-generator 306 is shown as I_{G} and the phase voltage of the electric motor-generator 306 is shown as V_{G}. The field current of the electric motor-generator 306 is shown as I_{F}. The voltage of the DC bus 310 is shown as V_{DC}. These parameters may be measured by current and voltage sensors.

The hybrid locomotive power system 300 includes a control circuit 316. The control circuit 316 generates output signals 318 to control operation of the active rectifier 308 and to control operation of the combustion engine 302. Additional details of the control circuit 316 are described below.

In some examples, the active rectifier is configured to operate as an inverter and regenerates energy by capturing power from the wheels and directing it to the DC bus 310 (or “DC link”). In accordance with this disclosure, the regenerated energy can be used to charge the battery pack. In addition and in accordance with this disclosure, the active rectifier may get the DC link energy and help spin the diesel engine shaft to reduce fuel consumption during idle mode.

In some examples, during a braking operation, the traction motor 212 of FIG. 2 is configured to operate as an electric generator, and the electric generator is configured to supply a charging current to the battery pack 312. For example, during the braking operation, the mechanical energy from braking turns the electric generator, which is configured to supply a current to charge the battery pack 312.

In some examples, during the braking operation, the electric motor-generator 306 is configured to operate as an electric generator, and the mechanical energy from braking turns the electric generator, which is configured to supply a current to a rotor of the electric generator to rotate the driveshaft 304 of the combustion engine 302.

In some examples, during the braking operation, the electric motor-generator 306 is configured to operate as an electric generator, and the mechanical energy from braking turns the electric generator, which is configured to supply a current to an electrical load 314 of the hybrid locomotive.

FIG. 4 is a schematic view of an example of the active rectifier 308 of FIG. 3. As seen in FIG. 4, the active rectifier 308 is coupled with the electric motor-generator 306, and further coupled with the electrical load 314 via the DC bus 310 (also referred to as the “DC link”).

The active rectifier 308 includes a plurality of transistors 400a-400f. The transistors are configured to selectively control a current flow 402 across a DC bus 310 coupled between the active rectifier 308 and the battery pack 312 (shown in FIG. 3). The active rectifier 308 includes a plurality of flyback diodes 404a-404f coupled with corresponding ones of the transistors 400a-400f.

A control circuit 406 is in electrical communication with the active rectifier 308 and configured to generate signals to control a switching operation of the plurality of transistors 400a-400f.

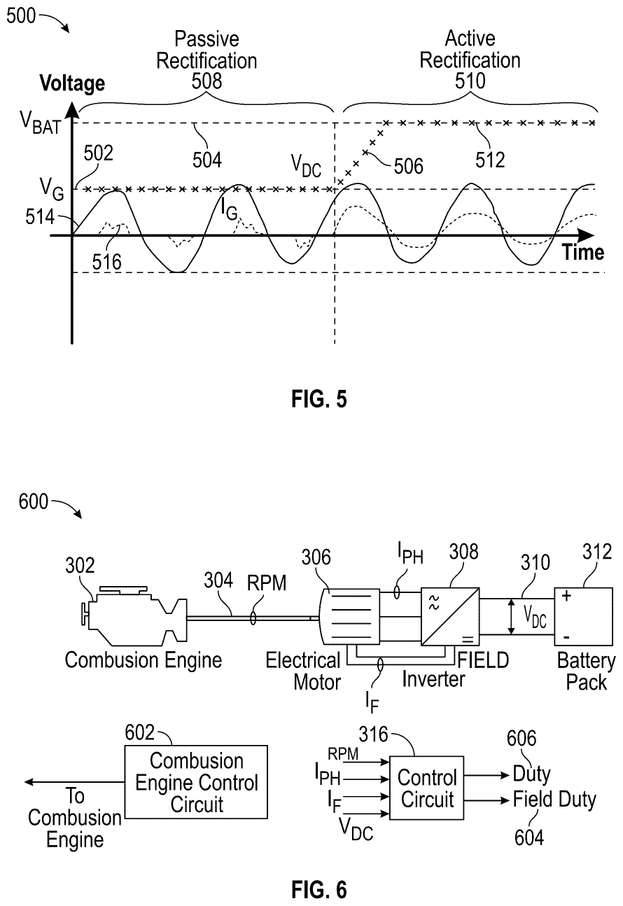

FIG. 5 is a graph 500 depicting voltage relationships in the hybrid locomotive power system. The x-axis depicts time and the y-axis depicts voltage. The graph 500 depicts the ability of the active rectifier to boost the DC link voltage, such as at low engine speeds, when the electric motor-generator, such as the electric motor-generator 306 of FIG. 3, is configured to operate as an electric generator.

The horizontal line 502 represents the peak electric generator voltage V_{G}. The horizontal line 504 represents the battery pack voltage V_{BAT}. The line 506 represents the DC link voltage V_{DC}.

Using the techniques of this disclosure and as described in more detail below, the DC link voltage V_{DC} (also referred to as DC bus voltage) may be boosted to match the battery voltage V_{BAT}. For example, as seen in FIG. 5, the graph 500 is divided into two portions representing passive rectification 508 and active rectification 510. During active rectification 510, a control circuit, described in detail below, boosts the DC link voltage V_{DC} from the peak electric generator voltage V_{G} to the battery pack voltage level V_{BAT}. More particularly, the graph 500 depicts the DC link voltage V_{DC} following the peak electric generator voltage V_{G} during the portion of passive rectification 508. Then, when the portion of active rectification 510 begins, the DC link voltage V_{DC} increases until it reaches or exceeds the battery pack voltage level V_{BAT}, as seen at line 512. In this manner, the DC link voltage V_{DC} may be boosted higher during the portion of active rectification 510, up to or beyond the level of the battery voltage V_{BAT}. When battery is connected to the DC bus, energy flows to the battery pack once the DC link voltage exceeds battery voltage V_{DC}. This technique allows for power sharing between the generator and the battery pack while maintaining proper voltage levels for system operation.

In addition, active rectification provides an improvement in power quality compared to traditional passive rectification systems. The time-varying electric generator voltage V_{G} is shown at 514 and the time-varying electric generator current I_{G} is shown at waveform 516. During the portion of passive rectification 508, the electric generator voltage V_{G} and the electric generator current I_{G} are not in phase. Although the voltage V_{G} is sinusoidal, the current I_{G} is not. In addition, the DC link voltage has a ripple and stays near the peak electric generator voltage V_{G}. The power quality is reduced during passive rectification due to the non-sinusoidal electric generator current I_{G} and phase mismatch between the electric generator current I_{G} and the electric generator voltage V_{G}.

Using the techniques described below and during the portion of active rectification 510 when the electric motor-generator is configured to operate as an electric generator, the active rectifier, such as the active rectifier 308 of FIG. 3, aligns the electric generator voltage V_{G} and the electric generator current I_{G} so that the two waveforms are in phase. In addition, the active rectifier adjusts the electric generator current I_{G} so that it is sinusoidal during the portion of active rectification 510. In this manner, the active rectification techniques of this disclosure improve the power quality through the sinusoidal current and phase alignment.

FIG. 6 is a block diagram of an example of a hybrid locomotive power system 600 that may be used to start the combustion engine. The hybrid locomotive power system 600 is similar to the power system 300 of FIG. 3, except that the electric motor-generator 306 is configured to operate as an electric motor, and the active rectifier 308 is configured to operate as an inverter, e.g., traction inverter. In this operational mode, the battery pack 312 is configured to supply the current flow to start the combustion engine 302 via the inverter and the electric motor.

The hybrid locomotive power system 600 includes the control circuit 316. The control circuit 316 receives sensor data as inputs from various sensors including a representation of a phase current I_{PH} for each phase associated with the electric motor, a representation of a field current I_{F} associated with a field of the electric motor, such as measured by a current sensor, a representation of a voltage V_{DC} associated with the DC bus 310, such as measured by a voltage sensor, and a representation of a speed of rotation (RPM) of the driveshaft 304, such as measured by a shaft encoder or a proximity sensor.

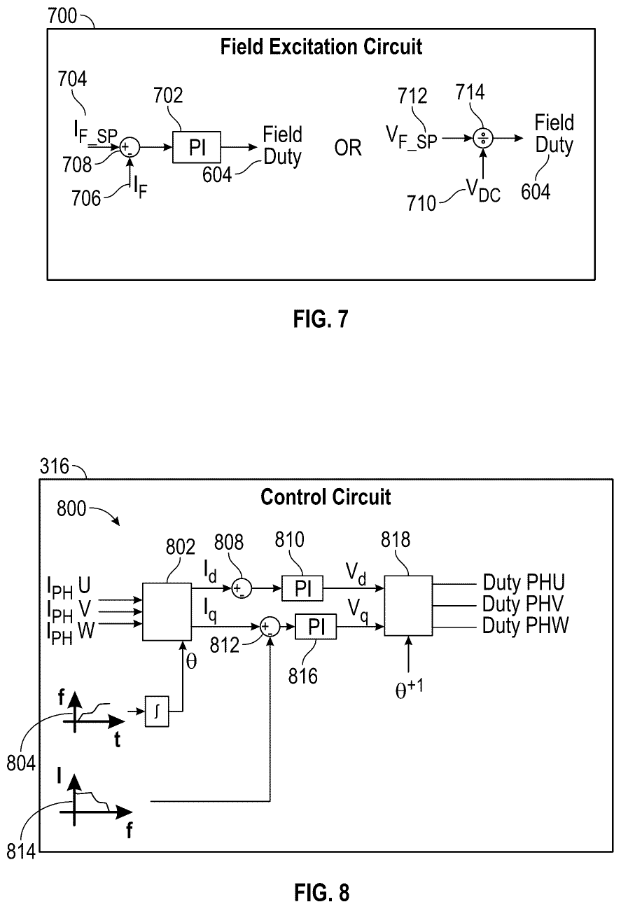

In response, the control circuit 316 generates various output signals including a field duty cycle signal 604 and a duty cycle signal 606. The field duty cycle signal 604 controls the switching of a plurality of transistors of a field excitation circuit associated with the electric motor (such as the field excitation circuit 700 shown in FIG. 7). The duty cycle signal 606 controls the switching of the plurality of transistors of the active rectifier 308 to control the current flow across the DC bus 310.

To start the combustion engine 302, the battery pack 312 feeds power to the active rectifier 308, which is configured to operate as an inverter. The inverter controls the electric motor, which rotates the driveshaft 304, and the combustion engine control circuit 602 starts the combustion engine 302. The combustion engine control circuit 602 includes a plurality of transistors and the combustion engine control circuit 602 controls the switching of the transistors to control the field of the electric motor.

FIG. 7 depicts an example of a field excitation circuit 700 implemented by the control circuit 316 of FIG. 6 to assist with engine start. In one example of generating a field duty cycle signal, the control circuit 316 includes a proportional-integral controller 702. A difference between a field current set point 704 and a field current 706 is determined, such as by a subtractor circuit 708. The difference is applied to the proportional-integral controller 702 to generate the field duty cycle signal 604. The field duty cycle signal 604 is applied to the combustion engine control circuit 602 in FIG. 6 to control the switching of transistors to control the field of the electric motor.

In another example of generating a field duty cycle signal, the control circuit 316 generates field duty cycle signal 604 based on a relationship between the voltage V_{DC} associated with the DC bus, shown at 710, and a field voltage set point 712. For example, a divider circuit 714 may determine a ratio of V_{DC} voltage to the field voltage set point 712 and, in response, generate a corresponding field duty cycle signal 604. In this example, the field duty cycle control uses voltage division between the field voltage set point and the DC link voltage V_{DC} to determine the appropriate duty cycle output.

For example, when the full DC link voltage is desired at the field coil of the electric motor, a field voltage set point equal to V_{DC} (such as 1000V/1000V) results in a duty cycle of 1.0 or 100%. To achieve a lower voltage at the field coil, such as 900V with a 1000V DC link, the division (900V/1000V) produces a duty cycle of 0.9 or 90%. This voltage-based control approach avoids oscillations in the field coil impedance that may occur when attempting to control current directly. The field duty cycle signal 604 is applied to the combustion engine control circuit 602 in FIG. 6 to control the switching of transistors to control the field of the electric motor to crank the engine.

FIG. 8 depicts an example of a current control loop 800 implemented by the control circuit 316 of FIG. 6 to assist with engine start. The current control loop 800 includes a rotational plane transformation 802 that is configured to receive various inputs including representations of the phase currents I_{PHU}, I_{PHV}, and I_{PHW} for each phase U, V, W, and a representation of an angular measurement θ, which is derived from a frequency profile 804 of a desired phase current. The frequency profile increases over time during engine start. The representation of an angular measurement θ is integrated by an integrator 806 before being applied to the rotational plane transformation 802. The rotational plane transformation 802 is configured to perform a Clarke transform and/or Park transform.

The rotational plane transformation 802 outputs two currents Id and Iq. The current Id is applied with a setpoint measurement θ to a summing circuit 808 and the difference is applied to a proportional-integral controller 810, which generates a voltage Vd. The current Iq is applied to a summing circuit 812 with a current profile 814 of a desired phase current and the difference is applied to a proportional-integral controller 816, which generates a voltage Vq.

The two voltages Vd and Vq are applied to an inverse rotational plane transformation 818 along with angular measurement θ+1, which forces the system to advance to the next angle step. The inverse rotational plane transformation 818 converts the voltages back to AC and generates duty cycle signals for each phase U, V, W. These duty cycle signals are then applied to the switches of the active rectifier, such as the active rectifier 308 of FIG. 3, to produce the desired current waveform and control the current flow across the DC bus. The current control loop 800 controls the current amplitude rather than individual points of the sinusoidal current.

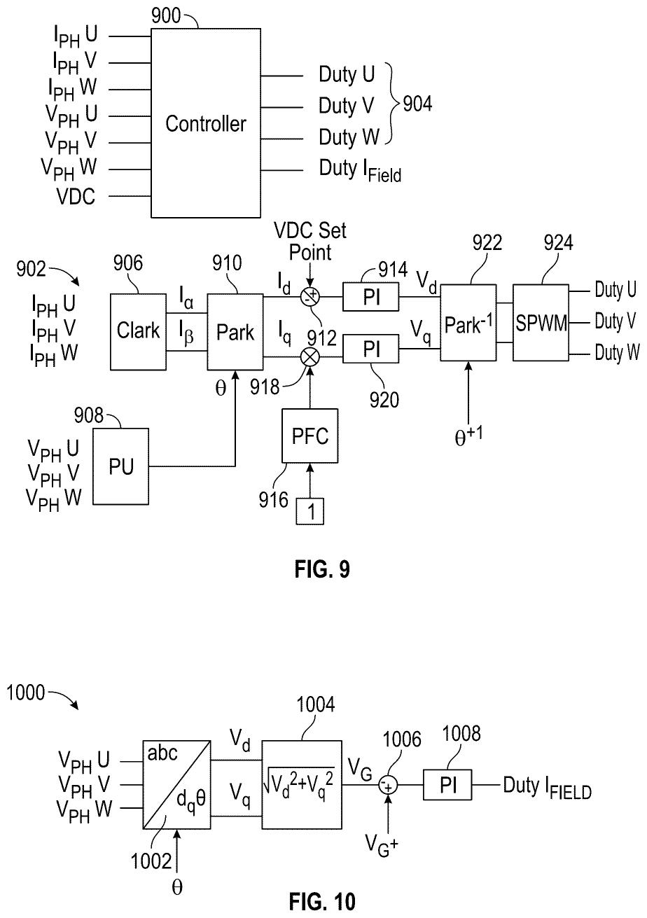

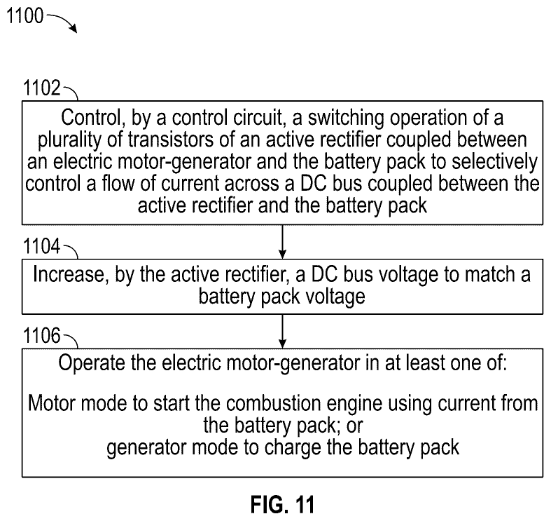

FIG. 9 depicts an example of a controller 900 and a control loop 902 implemented by the control circuit 316 of FIG. 6 to boost the DC link voltage V_{DC} to match the battery voltage V_{BAT}. The controller 900 is configured to receive various inputs, including representations of the phase currents I_{PHU}, I_{PHV}, and I_{PHW} for each phase U, V, W, the phase voltages V_{PHU}, V_{PHV}, and V_{PHW} for each phase U, V, W, and the DC link voltage V_{DC}. The controller 900 is configured to generate duty cycle signals 904 for each phase U, V, W and a field coil duty cycle signal I_{FIELD}. The control loop 902 forms part of the controller 900 and is used to generate the duty cycle signals 904 and the control loop 1000 in FIG. 10 is used to generate the field coil duty cycle signal I_{FIELD}.

The control loop 902 includes a Clarke transform 906 configured to receive the phase currents I_{PHU}, I_{PHV}, and I_{PHW} for each phase U, V, W and generate two DC currents Iα and Iβ. A phase-lock loop 908 receives phase voltages V_{PHU}, V_{PHV}, and V_{PHW} for each phase U, V, W. The phase-lock loop 908 tracks voltage angles by detecting zero crossings and generates an angle reference θ for synchronizing current with voltage.

A Park transform 910 receives the two DC currents Iα and Iβ from the Clarke transform 906 and the angle reference θ from the phase-lock loop 908 and, in response, generates two DC currents Id and Iq. The current Id is applied to a summing circuit 912 along with the setpoint for the DC link voltage V_{DC} and the difference (or error) is applied to a proportional-integral controller 914, which generates voltage Vd.

The control loop 902 includes a power factor controller 916. The power factor controller 916 is designed to achieve a unity power factor so as to minimize losses. A unitary power factor is desired, so the power factor controller 916 receives a “1” as input. The current Iq and the output of the power factor controller 916 are applied to a summing circuit 918 and the difference is applied to a proportional-integral controller 920, which generates voltage Vq.

The voltage Vd and Vq are applied to an inverse Park transform 922 along with angular measurement θ+1, which forces the system to advance to the next angle step. The output of the inverse Park transform 922 is applied to an inverse Clarke transform 924, which generates the duty cycle signals 904 for each phase U, V, W. The duty cycle signals 904 are applied to the switches of the active rectifier, such as the active rectifier 308 of FIG. 3.

FIG. 10 depicts an example of a control loop 1000 used to generate the field coil duty cycle signal I_{FIELD}. The control loop 1000 is implemented by the controller 900 of FIG. 9, which forms part of the control circuit 316 of FIG. 3.

A rotational plane transformation 1002 receives various inputs, including representations of the phase voltages V_{PHU}, V_{PHV}, and V_{PHW} for each phase U, V, W from the electric generator, and the angle reference θ from the phase-lock loop 908 in FIG. 9. The rotational plane transformation 1002 may perform both Clarke and Park transformations and generate two DC voltages Vd and Vq.

The two DC voltages Vd and Vq are applied to a peak voltage calculator 1004, which calculates the peak phase voltage V_{G} using the formula of the square root of (Vd²+Vq²). The peak phase voltage V_{G} and a peak phase voltage set point V_{G}′ are applied to a summing circuit 1006 and the difference is applied to a proportional-integral controller 1008. The proportional-integral controller 1008 generates the field coil duty cycle signal I_{FIELD}. If an increase in voltage is desired, the field coil duty cycle signal I_{FIELD} is increased and if a decrease in voltage is desired, the field coil duty cycle signal I_{FIELD} is decreased. The field coil duty cycle signal I_{FIELD} controls the switches in a buck converter that drives the field coil of the electric generator.

### INDUSTRIAL APPLICABILITY

FIG. 11 is a flow diagram of an example of a method 1100 of operating a hybrid locomotive having a combustion engine and a battery pack. At block 1102, the method 1100 includes controlling, by a control circuit, a switching operation of a plurality of transistors of an active rectifier coupled between an electric motor-generator and the battery pack to selectively control a flow of current across a DC bus coupled between the active rectifier and the battery pack.

At block 1104, the method 1100 includes increasing, by the active rectifier, a DC bus voltage to match a battery pack voltage.

At block 1106, the method 1100 includes operating the electric motor-generator in at least one of: 1) a motor mode to start the combustion engine using current from the battery pack; or 2) a generator mode to charge the battery pack.

In some examples, operating in the generator mode includes aligning, by the control circuit, a voltage waveform generated by the electric motor-generator with a current waveform generated by the electric motor-generator so that the two waveforms are in phase. Aligning the two waveforms enables voltage boosting that allows for effective battery integration by matching required voltage levels.

In some examples, operating in the motor mode includes receiving, by the control circuit, sensor data from sensors representing: phase currents for each phase associated with the electric motor-generator; a field current associated with a field of the electric motor-generator; a voltage associated with the DC bus; and a speed of rotation of a driveshaft coupled between the combustion engine and the electric motor-generator; generating a field duty cycle signal to control switching of transistors of a field excitation circuit; and generating a duty cycle signal to control the switching of the plurality of transistors of the active rectifier.

The active rectifier and control circuitry allows for power quality improvement through active rectification compared to traditional passive rectification systems. The active rectifier system may operate in reverse as an inverter to provide engine cranking capability. Additionally, the active rectifier system incorporates regenerative braking with the ability to distribute power between batteries and auxiliary loads.

What is claimed is:

1. A hybrid locomotive including a combustion engine and a battery pack, the hybrid locomotive comprising:
an electric motor-generator coupled with the combustion engine, wherein a driveshaft of the combustion engine is coupled with the electric motor-generator;
an active rectifier coupled between the electric motor-generator and the battery pack, wherein the active rectifier includes a plurality of transistors configured to selectively control a flow of current across a DC bus coupled between the active rectifier and the battery pack, wherein the active rectifier is configured to increase a DC bus voltage to match a battery pack voltage; and
a control circuit in communication with the active rectifier and configured to control a switching operation of the plurality of transistors.

2. The hybrid locomotive of claim 1, wherein the electric motor-generator is configured to operate as an electric generator, and wherein the control circuit is configured to align a voltage waveform generated by the electric generator with a current waveform generated by the electric generator so that the voltage waveform and the current waveform are in phase.

3. The hybrid locomotive of claim 1, wherein the electric motor-generator is configured to operate as an electric motor, wherein the active rectifier is configured to operate as an inverter, and wherein the battery pack is configured to supply current to start the combustion engine via the inverter and electric motor.

4. The hybrid locomotive of claim 3, comprising:
the control circuit configured to:
receive a representation of a phase current for each phase associated with the electric motor;
receive a representation of a field current associated with a field of the electric motor;
receive a representation of a voltage associated with the DC bus;
receive a representation of a speed of rotation of the driveshaft;
generate a field duty cycle signal to control a switching of a plurality of transistors of a field excitation circuit associated with the electric motor; and
generate a duty cycle signal to control a switching of the plurality of transistors of the active rectifier to control a current flow across the DC bus.

5. The hybrid locomotive of claim 4, wherein the control circuit includes a proportional-integral controller, and wherein the control circuit configured to generate the field duty cycle signal to control the switching of the plurality of transistors to control the field of the electric motor is further configured to:
apply a difference between a field current set point and the representation of the field current to the proportional-integral controller to generate the field duty cycle signal.

6. The hybrid locomotive of claim 4, wherein the control circuit configured to generate the field duty cycle signal to control the switching of the plurality of transistors to control the field of the electric motor is further configured to:
generate the field duty cycle signal based on a relationship between the voltage associated with the DC bus and a field voltage set point.

7. The hybrid locomotive of claim 4, wherein the control circuit configured to generate the duty cycle signal to control the switching of the plurality of transistors of the active rectifier to control the current across the DC bus is further configured to:
perform, using a profile of a desired phase current, a rotational plane transformation of phase currents for each phase.

8. The hybrid locomotive of claim 7, wherein the profile includes a frequency profile and a current profile of the desired phase current.

9. The hybrid locomotive of claim 1, wherein, during a braking operation, the electric motor-generator is configured to operate as an electric generator, and wherein the electric generator is configured to supply a charging current to the battery pack.

10. The hybrid locomotive of claim 9, wherein, during the braking operation, the electric generator is configured to supply a current to an electrical load of the hybrid locomotive.

11. The hybrid locomotive of claim 9, wherein, during the braking operation, the electric generator is configured to supply a current to a rotor of the electric generator to rotate the driveshaft of the combustion engine.

12. A method of operating a hybrid locomotive having a combustion engine and a battery pack, the method comprising:
controlling, by a control circuit, a switching operation of a plurality of transistors of an active rectifier coupled between an electric motor-generator and the battery pack to selectively control a flow of current across a DC bus coupled between the active rectifier and the battery pack;
increasing, by the active rectifier, a DC bus voltage to match a battery pack voltage; and
operating the electric motor-generator in at least one of:
a motor mode to start the combustion engine using current from the battery pack; or
a generator mode to charge the battery pack.

13. The method of claim 12, wherein operating in the generator mode comprises:
aligning, by the control circuit, a voltage waveform generated by the electric motor-generator with a current waveform generated by the electric motor-generator so that the voltage waveform and the current waveform are in phase.

14. The method of claim 12, wherein operating in the motor mode comprises:
receiving, by the control circuit, representations of:
phase currents for each phase associated with the electric motor-generator;
a field current associated with a field of the electric motor-generator;
a voltage associated with the DC bus; and
a speed of rotation of a driveshaft coupled between the combustion engine and the electric motor-generator;
generating a field duty cycle signal to control switching of transistors of a field excitation circuit; and
generating a duty cycle signal to control the switching of the plurality of transistors of the active rectifier.

15. A control system for a hybrid locomotive having a combustion engine and a battery pack, comprising:
an active rectifier coupled between an electric motor-generator and the battery pack, the active rectifier including a plurality of transistors configured to selectively control current flow across a DC bus coupled between the active rectifier and the battery pack; and
a control circuit configured to:
control switching of the plurality of transistors to operate the active rectifier as a rectifier during a generator mode and as an inverter during a motor mode;
increase a DC bus voltage to match a battery pack voltage during the generator mode; and
control current flow from the battery pack to start the combustion engine during the motor mode.

16. The control system of claim 15, wherein the control circuit is further configured to:
align a voltage waveform with a current waveform generated by the electric motor-generator during the generator mode.

17. The control system of claim 15, wherein the control circuit is further configured to:
receive sensor data representing operating parameters of the hybrid locomotive; and
generate duty cycle signals for the plurality of transistors based on the sensor data.

18. The control system of claim 17, wherein the sensor data includes:
phase currents for each phase of the electric motor-generator;
a field current;
a DC bus voltage; and
a driveshaft rotation speed.

19. The control system of claim 15, wherein during a braking operation, the control circuit is configured to:
control the active rectifier to direct regenerative current to at least one of:
the battery pack for charging;
an electrical load of the hybrid locomotive; or
a rotor of the electric motor-generator.

20. The control system of claim 15, wherein the control circuit is configured to:
perform a rotational plane transformation of phase currents based on a profile including frequency and current parameters.
